(19) United States
(12) Patent Application Publication
(10) Pub. No.: US 2009/0123604 A1
(43) Pub. Date: May 14, 2009

(54) EMULSION FOOD INGREDIENT

(76) Inventors: Marcel St-Jean, Lachenaie (CA); Pierre LaHaye, Montreal (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/577,282

(22) PCT Filed: Oct. 21, 2005
(86) PCT No.: PCT/CA05/01619

§ 371 Date: Apr. 13, 2007

(30) Foreign Application Priority Data
Oct. 29, 2004 (CA) 2,486,324

(51) Int. Cl. A23C 13/12

(52) U.S. Cl. 426/61; 426/586; 426/72; 426/417

(57) ABSTRACT

An oil-in-water emulsion for use as a cream substitute in the food industry is provided. The oil-in-water emulsion is based on a mixture of vegetable, marine and/or fish oil(s), milk protein and water. The emulsion can further comprise optional lipophilic and hydrophilic constituents. The emulsion of the present invention contains reduced amounts of saturated fat, cholesterol, trans fatty acids and is preferably further fortified with poly-unsaturated fatty acids (PUFAs). The emulsion is a suitable cream substitute which remains stable when heated and/or when in contact with strongly acidic or alcoholic ingredients. A method to prepare the emulsion is also provided.

### FIELD OF THE INVENTION

The present Invention relates to a vegetable, marine and/or fish oil(s)-in-water emulsion, which can be used as a fat or cream substitute in food products which normally contain dairy cream, to methods of preparing the cream food ingredient substitute and to various foodstuffs prepared with the cream food ingredient substitute in place of some or all of the cream (dairy or substitute) such foodstuffs typically are prepared with.

### BACKGROUND OF THE INVENTION

Milk and cream are natural oil-in-water emulsions in which the milk fat is finely dispersed in the excess component, water, in the form of droplets. These products can be further prepared to accommodate human consumption in various food recipes by standardizing the fat content, filtrating and/or membrane separating, pasteurizing (and/or ultra-heat treating and/or sterilising) and finally homogenizing the resulting products.

Along with the natural constituents contained in the milk (such as water, butterfat, lactose, organic and mineral salts, whey proteins and caseins) further additives can be used to improve given characteristics such as whippability, creaminess, cooking tolerance, thickness, colour, etc. required for specific usages.

In recent years, various types of cream substitutes have been designed, often made of vegetable oils or fats with numerous additives such as stabilizers, sugars, colours, thickeners to name a few. These products have become an attractive, if not economical, alternative to conventional dairy creams. They are called, among other things, analogue creams, artificial creams, vegetable oil creams, imitation creams or cream substitutes. Demands for these products has significantly increased for reasons of convenience to manufacturers such as economical price, easiness of handling, high quality controlled standards, greater consistency, easy availability in distribution channels having less control in the chains of cold, etc.

In addition to above qualities, cream substitutes, depending on their compositions, have generally a reduced cholesterol content (compared with natural dairy creams) which suits more the health-conscious consumers. Certain artificial creams, free of any milk components, accommodates also religious consumers (e.g. Muslims and Jews) seeking appropriate food constituents.

However, many of these artificial creams can contain gelatin for texture and stability of the end product. Unfortunately, recent discoveries of BSE (Bovine Spongiform Encephalopathy) in related constituents make this approach also highly undesirable.

Another important aspect of cream substitutes is their general diminution (or even absence) of cholesterol. It is scientifically proven and supported by European and North American Medical Heart Associations (as well as other governmental medical authorities) that cholesterol, with the addition now of saturated and trans fatty acids as new culprits, are leading causes of heart diseases, strokes and other blood vessels diseases. Moreover the general intake of saturated fats, highly present in dairy fat at 66%, causes elevated blood cholesterol levels in a large segment of the population.

Modern nutritionists have since targeted drastic reduction of saturated fats and cholesterol intakes along with elimination of trans fatty acids in the human diet as a mean to prevent such heart and coronary disorders in the general population regardless of age, sex and ethnicity.

In order to alleviate these problems, food manufacturers, and particularly food ingredient designers, have developed modified milk products having in mind the reduction of the bad constituents while closely approximating fresh whole milk and cream in taste, body and appearance. Several attempts by dairies and other food ingredient manufacturers have been made to remove the cholesterol from the butterfat (averaging from 293 to 384 mg of cholesterol per 100 g) through chemical and/or physical processes (often not cost effective) but without replicating the taste of whole milk. New cholesterol-free or cholesterol-reduced formulations are still constantly introduced in the market but, again, without being satisfactory in the most important regard:taste. Many other approaches have been tempted in playing with various chemicals and oils in order to duplicate the rheological properties of milk and dairy creams along with its unique taste.

Milk products having reduced saturated fat content, for example skimmed milk, are prepared by separation of the milk fat from the whole milk. The addition of a vegetable fat (or mixture of) to the skim milk produces a mil product generally known ads a filled milk product. Of course, such filled skim milk can be further processed in a concentrated liquid or dried form. It is well known for those skilled in the state of the art to prepare new oil-in-water emulsions to be used as cream substitute by adding additional milk components (such as skim milk or buttermilk powders) and, as such, replace dairy creams in food formulations.

Let review some remarkable but full-commercially incomplete patented approaches which are all lacking at least one of the fundamental characteristics sought by the health conscious consumers which is an adequate and balanced lipid profile as per our invention.
A dry milk prepared from skim milk and vegetable fat is described in Howard et al. (U.S. Pat. No. 2,659,676). The product is manufactured via normal steps generally known to those skilled in the art such as separating the butterfat from whole milk, replacing the butterfat with, at least, half the fat by palm oil, admixing lecithin, pasteurizing, homogenizing and drying.
Similar product and process have been designed and used by Baurer (U.S. Pat. No. 2,871,123) to produce various filled products in liquid forms such as a canned calcium-enriched milk.
A milk with reduced saturated fat content is illustrated by German Offnlegungsschrift 2,444,213 by evaporating milk to increase solids concentration and mixing poly-unsaturated fats (including esters of linoleic and linolenic acids) prior to homogenization, re-pasteurisation and drying.
More simply Kneeland (U.S. Pat. No. 3,011,893) describes an evaporated milk-like product prepared directly from powdered skim milk to which water and vegetable oil are mixed while preheating before pasteurisation.
Bundus (U.S. Pat. No. 3,488,198) describes a filled milk based on a water-in-oil emulsion (0.05-0.5%) with 1-10% vegetable fat (from various sources although most of his examples uses coconut oil), 5-10% skim milk solids and water to complete. Preferably the filled milk product includes a small amount of cephalin-containing lecithin.
Similarly Hauser et al. (Canadian Patent 462,146) proposed a canned filled milk prepared by vigorously agitating a mixture of skim milk and vegetable oil at a temperature pf approximately 210.degrees. F., producing an emulsion further agitated under vacuum at a temperature of about 130.degrees.F. while introducing vitamins A and D.

Rather than milk derivatives as seen above, cream substitutes have been designed to be added to other ingredients of food products to make culinary products such as sauces, gravies, soups, desserts and pastries.
U.S. Pat. No. 4,146,652 of Kahn discloses an intermediate moisture food, stable at freezer temperatures. Composed mainly of water (0.75 to 0.9) and sugar (preferably in a ration 1-2:1 containing at least 5% dextrose and/OT fructose), this product covers oil-in-water emulsions, butter creams, whipped toppings, low-fat whipped creams, milk mates, non-dairy shakes, icings and coffee creamers.
Alternatively G.B. 1,066,703 designed an imitation cream concentrate comprising 40-70% fat, 20-50% water, 10-40% of one or more sugars, whole milk powder, separated milk powder and one or more starch derivatives selected for their affinities to water/air or water/fat lipophilic emulsifying properties. B.P. 0 714 609 disclosed a cream-like composition comprising 16-40% oil and fat, 0.3-6% admixed protein and sugary materials to bring total solids content to 35-70% by weight along with water brought to emulsification.
Similarly G.B. 1,077,338 disclosed an edible whipping composition comprising a first spray dried mixture <of edible fat (30-75%), a sweetener (10-60%), a water soluble protein (7-12%) and a water soluble gum (2-10%) as a coating agent> blended to a second spray dried mixture <of a water soluble gum (80-95%) with acidic stiffening agent (5-20%)>.

More specifically, the following patents
E.P.0436994B1
E.P.0454195B1
E.P. 0 469 656 B1 which requires specifically butter milk powder
E.P. 0463 593 B1
and more recent EP 0 714 609
   take in consideration the casein and whey proteins contained in milk to contribute to emulsion stability, maintenance of the cream structure (if whippable cream substitutes are considered) and improvement in taste. However, the use of such straight and natural milk proteins has the disadvantage of denaturing in an acidic environment or increased temperatures while being complexed by di- or poly-valent metal ions leading to precipitation.
But in FR 2 185 018 whippable creams are disclosed that are based on polyunsaturated fatty acids. In order to achieve acceptable product performance the water phase should be slightly acidic, while simultaneously the water phase should contain 0.5-4 wt % of globular protein and flocculating compounds should be absent in the water phase to overcome protein denaturation.
More complex is the Japanese patent 58116-647 where the whippable cream consists of 0.1-2% of a sugar fatty acid, 0.5-5% of triglycerides with a melting point of at least 50.degrees.Celsius and 0.05-0.5% of pyrophosphoric acid or its salts.
GB 2 162 039 has created non-dairy cream that contains a soybean aqueous infusion, a soy cellulose, admixed with vegetable oil and/or hardened vegetable oil and alginic acid derivatives or gelatin, a sugar ester and a polyphosphate salt.
U.S. Pat. No. 3,979,526 proposed a soft foam consisting of defatted milk products (dialysed milk) emulsified with vegetable oil.

Alternatively another approach has been designed by the following patents
E.P. 0 509 579 B
E.P. 0 691 080 A2
   to use di-, tri- or tetra-valent metal slats or alkaline earth metal salt (suitable for nutrition purposes) for the preparation of fat-in-water emulsions. D.D. 232 191 A1 product contain a broad bean isolate (or its acetylated form) without any milk solids. Not only these products require very precise concentration settings (in order to obtain adequate emulsion viscosity without precipitation of the protein fraction) but they are not really accepted by the consumers (e.g. coffee whiteners) due to their metallic tastes.
Improvements to above products have been made by the following patents
   E.P. 0 455 288 B1
   E.P. 0 483 896 B1
   E.P. 0 509 579B1
   E.P. 0 540 086 A1
   and more recent EP 0 714 609 A2 vin which whippable non-dairy creams are created using various proteins as optional components. However no water-soluble carbohydrates (e.g. saccharose) are included in them preventing these cream substitutes to be used as filling or topping for cake, pastry and dessert products.

More recently EP 0 558 113 B1 has extended the concept to water-continuous emulsions but based on polysaccharides to obtain gelling characterisrics.

Spoonability of non-dairy creams has also been directly addressed. EP 294 119 required a specific N-line of fatty acids to obtain desired mouth feel and EP 0 483 896 B1 declined a whole set of rheology values to obtain such spoonability characteristics from various blend of dairy fats with vegetable oils. EP 0 691 080 B1 extended the concept to low fat products.

Another field of cream substitute mixtures has been patented for the specific preparation of ice creams and frozen desserts. Although many of these original products do have Standards of Identity, there is plenty of room in legislation to add “chemicals” to dairy components in order to improve certain characteristics.

It is well known that the fat content of frozen dairy desserts delimitates not only its flavour but also its broad appearance and texture. Smoothness of ice cream texture is essentially inversely proportional to the average size of ice crystals. Higher fat content of ice creams diminishes ice crystal size and the distance between ice crystals giving, thus, increased palatability, smoothness, body and texture.

Attempts have been made to develop frozen dessert products formulations where dairy fat content in replaced by non-fat materials. Unfortunately none of the resulting products has achieved substantial success. For example, U.S. Pat. No. 4,510,166 uses starch gels as dairy fat replacement material and U.S. Pat. Nos. 4,421,778 and 4,552,773 incorporate beta-phase tending crystalline fats to overcome the problem. Although several patents cover this approach to high non-dairy fat ice creams (such as B.P. 915,389, U.S. Pat. No. 3,510,316; U.S. Pat. No. 3,556,813 and U.S. Pat. No. 4,400,405) but no satisfactory products have come up commercially.
U.S. Pat. No. 4,421,778 created a freezer stable whipped ice cream (and milk shakes products) and U.S. Pat. No. 4,552,773 have pushed the concept further to prevent crystallization of the lactose present in the non fat milk solids by using, in the fat phase, at least 50% of a solid beta-phase-tending crystalline fat and microcrystalline cellulose and sodium carboxy methylcellulose.
Alternatively U.S. Pat. No. 4,631,196 has designed a low cholesterol, low calorie, no fat dairy product to used as a frozen mousse but consisting of traditional ingredients such as milk proteins (from slim milk or cultures skim milk), sugars, stabilizers and emulsifiers.
U.S. Pat. No. 4,985,270 has substantially improved the range of cream substitutes by disclosing non-fat and reduced fat whipped frozen dessert wherein proteinaceous macrocolloids are used consisting of denatured whey protein particles or particles having a core of casein surrounded by a shell of denatured egg white protein.
U.S. Pat. No. 5,393,551 proposed a simple butterfat substitute consisting of a partially hydrogenated soybean oil with mono- and diglyceride components
EP 454 195 created also a canned non-dairy cream aerosol to be used with a N20 propellant.
U.S. Pat. No. 5,462,755 extended further the concept of dairy fat substitutes by using them as flavor enhancement products in cultured dairy products. Their approach combines particular sequences of addition of selected fat fractions (for crystallization and melting points properties) in the fermentation manufacturing process.
U.S. Pat. No. 5,080,912 prepared a cheese product from polyol fatty acid polyesters as fat substitute by following a very strict sequence of fabrication including tight control of the average oil droplet size to less than 20 microns.
U.S. Pat. No. 5,112,626 created frozen aerated dessert compositions without any fats by substituting them with hydrolysed starch.
Finally, recently, US 20 020 119 238 disclosed a creamy oil-in-water emulsion totally milk-free to be used in cake and pastry and dessert products. Its characteristic consists of emulsifying two previously admixed phases: the aqueous phase (water, carbohydrate, hydrocollid and optionally other hydrophilic constituents) with the oily phase (edible oil or fat, emulsifier and optionally further lipophilic constituents).

There thus continues to exist a long standing need in the art for an o/w emulsion cream substitute stable to heat, stable to high acid (i.e. pH 1 to 5), stable to alcohol (e.g. wine, liquor, etc.) containing significantly reduced levels of saturated fats, no cholesterol, no trans fatty acids, fortified with poly-unsaturated fatty acids PUFAs of omega-3 types and while approximating the taste, texture, appearance, body and mouth feel of butterfat.

### SUMMARY OF THE INVENTION

It is accordingly an object of the present invention to provide a particular oil-in-water emulsion intended to:
contain vegetable, marine and/or fish oil(s) in lieu of replacing totally or partially the butterfat or dairy fat
contain a milk protein to keep the fat/water globules of the emulsion in total affinity with other dairy products
not contain any cholesterol
have significantly less saturated fatty acids compared to butterfat or dairy fat
not contain trans fatty acids (often present in vegetable hydrogenated oils generally used in filled milk products)
contain essential poly-unsaturated fatty acids form vegetable, marine and/or fish sources in the form of short and long chains of omega-3s
be stable at low pH (below 5)
be stable with alcohols
have a liquid creamy consistency and high emulsion stability
have a gel solid-like form while being easily dispersible in other liquids such as milk, or cream, or water, or alcoholic beverages
remain mechanically stable in a whipped form or in aerated products
have improved microbiological resistance fue to its low water activity and increased shelf-life
have high freeze-thaw resistance, suitable for frozen desserts, ice creams and other table delicacies
be a vehicle to lipophilic and hydrophilic food additives (such as colouring agents, natural or artificial aromas, olfactory agents or preparations, aromatic preparations, natural or artificial flavours (like, for example, spices and seasonings) including potentiators, bio-active and/or nutraceutical ingredients, micro-organisms (like bacteria, yeasts and moulds) whole or hydrolyzed proteins (including enzymes), antimicrobial food additives, antioxidants, stabilizers and surface active agents, acidulants, sweeteners, sequestrants agents, gums and starches, vitamins and aminoacids, food stabilizers, organic minerals (chelated or not), inorganic minerals, food ingredients such as cereals, eggs, fruits and vegetables, meats and giblets and medicines and drugs.
approximate the taste, body appearance, texture and total experience of the milk product which it is replacing.

In order to achieve these objects, a creamy oil-in-water emulsion is proposed which is characterized in that it contains:
a) an oil phase, which comprises edible oil and/or edible fat and optionally further lipophilic constituents
b) a protein denaturization step, which comprises the addition to a) of a high viscosity sodium caseinate under controlled agitation and temperature ranges
c) an aqueous phase, which contains water and, optionally further hydrophilic constituents;
   the weight ratio of the oil phase to the aqueous phase (A:c) being in the range from 6:4 to 1:9 and the weight ratio of the protein to the oil and water phases being in the range from 0.04:0.96 to 0.12:0.88
d) to emulsify, under very controlled parameters of temperature and agitation, the oil phase (a), to which protein (b) was added to the water phase (c) in order to create a stable o/w matrix ready to receive other lipophilic or hydrophilic constituents (if not already added). According to the Invention, the o/w emulsion can also simply consists of the oil phase (a), the protein (b) and the aqueous phase (c).

A subject of the Invention is also a process for the preparation of the creamy emulsion according to the Invention, which is characterized in that:
a) edible oil and/or edible fat, of vegetable, marine or fish origins, or a mixture of some or all the above, is heated to a temperature ranging from 55.degrees.Celsius to 120.degrees.Celsius and, optionally, to which part of all the lipophilic constituents are mixed in the heated oil(s);
b) a high viscosity sodium caseinate milk protein is added to the oil phase a) under controlled temperature and agitation depending on the degree of denaturization of the protein desired which determines, partly, the fluidity of the product of the Invention;
c) water is heated separately ideally at the same or close to the temperature of a) and, optionally, part or all the hydrophilic constituents are mixed in the heated water;
d) the oil phase a) is dispersed into the water phase c) to make a proper emulsion;
e) the resulting o/w emulsion can received further lipophilic and/or hydrophilic solids;
f) the emulsion can, optionally, by further homogenized under any pressure but, preferably, to 2 000 psi at first stage and 500 psi at the second stage;
g) the emulsion optionally can be heat-treated (pasteurized, sterilized or ultra-high heat-treated);
h) the obtained cream substitute is directly packed or just cooled prior to further conditioning.

A subject of the Invention is furthermore the use of the cream substitute, made according to the Invention, in various food formulations replacing partly or wholly dairy creams or other types of cream substitutes.

There is no other existing inventions combining such characteristics described above with these:beneficial to human nutrition, economical to food manufacturers and bringing a simple food ingredient to a wide variety of products ranging from sauces to soups, cheeses to yoghurts, ice creams to frozen desserts and delicacies, fluid milk beverages to cream substitutes.

### DETAILED DESCRIPTION

The proportions given in weight percent of the individual components refer, unless stated otherwise, to the sum of the previous constituents weights prior to the addition of a new specific constituent.

According to the Invention, the edible oils and/or edible fats customary for nutrition purposes are used as edible oils and fats or mixtures of. Vegetable oils, such as canola, olive, palm, sunflower, safflower, flax seed, soya, almond, corn, rapeseed, coconut, to name a few, technologically modified derivatives of the above-mentioned oils and fats or mixtures of two or more of the same are preferably used. Marine or fish oil(s), obtained from various sources such as algae, krill, menhaden, anchovy, mackerel, tuna, to name a few, technologically derivatives such as common ethylester or others, of the above mentioned oils, or mixtures of two and more of the same are preferably used.

The proportion of oil in the final cream substitute is 2 to 55 wt.-%, preferably 30 to 50 wt.-%, most preferably 42-45 wt.-%.

It has been determined according to the present Invention, that not all proteinaceous materials, even from milk origin, are adequate to create water-dispersible macrocollids in an oil emulsion as a cream substitute. In order to obtain a cream substitute which is thermo-irreversible (meaning that cycles of freeze-thaw will not change the physical structure of the cream), which demonstrates great rheological affinities with other milk components (such as milk itself, even devoid of all butterfat) or milk preparations such as cheese or yoghurt, which is stable from a frozen state to room temperature to sterilisation environment, which may contain other food additives regardless of their dissolving powers in water or oil, which demonstrates extended shelf-life greater than dairy creams in terms of physical stability and lower in microbiological loads, it is necessary to use a modified solubilized casein such as sodium caseinate of high viscosity, preferably measured via a Brookfield viscosimeter in a 15% solution at 20° C., in a range greater than 1 500 Pa.sec, most preferably greater than 2 000 Pa.sec. The ratio of the proteinaceous material to the combined weights of oil and water is 5 to 10 wt.-%, preferably 5 to 7 wt.-%, most preferably 6.25 to 7.25 wt.-%.

Denaturation of the proteins is obtained through a combination of vigorous agitation coupled with temperature. Rather than trying to control the degree of denaturization of the proteins, the Invention uses a scale of temperatures, regardless of the contact times, to achieve the final fluidity of the cream: higher processing temperatures meaning firmer creams. The uncommon denaturization procedure is carried out without pH adjustment. Normal practices in protein denaturization require that pH be adjusted to a pH less than the mid-point of the iso-electric curve of the protein, preferably at about one unit of pH less or even lower. The procedure according to the Invention does not command such chemical manipulations relying solely on temperature and high shear agitation. The precise temperatures and shear conditions applied to the preparation are routinely selected and extend out for times sufficient to form denaturizated proteinaceous colloids which show a cream-type texture in the oil(s) selected. The high level of shear useful in the preparative processing is believed to prevent the formation of large denatured protein aggregates during denaturization and during the emulsification step with the aqueous solution. There is no need to add aggregate blocking agents whatsoever. Suitable and common aggregate blocking agents like hydrated anionic materials such as xantham gums, lecithin, carragenean, alginate, calcium, stearoyl lactylate, malto-dextrins, pectin and the like are all unnecessary for this purpose of preventing aggregate formation.

This distinct property of fluidity without aggregates does not command further homogenization as an obligatory step to create a cream-like emulsion. Such a treatment is not even desirable in the case of products which are diluted or neutralized. If any of the traditional homogenization treatments known in the art is employed, it is in the only purpose of improving organoleptic characteristics of the end-product, knowing that smaller and finer globules create a greater sensation of smoothness in the mouth.

The temperature range of the oil is from 55 to 120.degrees.Celsius, preferably from 60 to 100.degrees.Celsius, most preferably at 65-70.degrees.Celsius. The contact time between the oil(s) ans the protein ranges from time of addition for immediate processing to 20 minutes. Longer time tends to denature the proteins by cooling them to form sandy crystals rather than unfolding the protein back-bone or disassembling the protein quaternary and tertiary structures.

The water phase, composed at minimum of water only, is maintained in the same temperature range as the oil phase, preferably within plus or minus 20.degrees.Celsius of the oil phase, most preferably at the same temperature. This concordance of temperatures between the phases facilitates the emulsion without changing the denaturization states of the protein.

Emulsification is made in a vessel where the two phases are added one on top of the other and through sudden vigorous agitation (minimal tip speed of agitator blades is 40 feet.per.second). Emulsification can also be achieved by having the blended phases go through an emulsifying pump. Tolerance between stator and rotor depends on final volume of globules desired. The finer the size of the globules, the smoother is the cream substitute. Range from 0.1 to 20 microns are acceptable, preferably less than 2 microns, most preferably less than 0.5 micron.

Furthermore, any food additive or combination of food additives can be added or at the oil phase, or at the water phase, prior to emulsification or at a later stage by proper mixing. The proportion of solids, generally added to impart specific properties (colour, flavour, texture or fortification), does not change the basic characteristics of the cream substitute according to the Invention. The food additives can be chosen in the broad field of intentional food additives as permitted by local legislation and by-laws.

After emulsion is made and additives are dissolved or dispersed, the resulting cream substitute can be homogenized and sterilised or vice-versa. Homogenization and sterilisation are done like milk products under the same parameters, well known to those skilled in the art. Conditioning and packaging are made like any other milk products.

Surprisingly the cream substitute of the Invention is storage-stable in a pH range from 2 to 12. Storage-stable means that the emulsion can be stored for at least a year at a temperature of 1.degree.Celsius to 40.degrees.Celsius without relevant chemical or physical changes occurring. Of course, such shelf-life depends on aseptic packaging previously achieved and the pH of the product.

This storage-stability has the distinct advantage that acidulant or alcoholic chemicals can be incorporated into the emulsion during its preparation and, thus, impart long shelf-life. For example, alcoholic beverages and liquors such as Bailey's (milk cream with Irish whisky) can be made without adding any stabilizer to the cream substitute.

Alternatively, acid food products, such as fruits, fruit preparations, fruit syrups, fruit juices can be added to fermented or sour milk substitutes made with the Invention or yoghurt substitutes made with the Invention or mixtures of two or more of the same.

Also, neutral food products being for example chocolate or vanilla preparations, or mixtures of the same, can be made just by blending appropriate flavours into the cream substitute.

In all cases described, the weight ratio of cream substitute of the Invention to acid, neutral and/or alcoholic containing food product is limitless, varying to the degree of flavour and the texture desired. Such products can be conditioned under any food packages according to procedures known to those skilled in the art and be kept from room temperature to freezing, even with sudden interruption of the chain of cold, without changing its texturized properties.

The cream substitute according to the Invention is thus suitable to be used as a substitute, partly or wholly, for conventional dairy creams (or other cream substitutes) in any food formulation where such creams are used.

Additional objects, advantages and novel features of the present Invention are set forth in the examples that follow and in part will become apparent to those skilled in the art upon examination of the previous description or may be learned by practice of the Invention. The objects and advantages of the Invention may be realized and attained by means of instrumentalities and combinations particularly pointed out in the examples.

The following examples illustrate the Invention while not limiting any claims of the Invention. All percentages are weight/weight except when explicitly said.

### EXAMPLE 1

A gelified cream substitute is made from a simple fat source of vegetable canola oil by mixing 44.6 kg of the said oil, heated at 90° C., with 8.9 kg of sodium caseinate using a Roto-solver agitator. Then, 44.6 kg of hot water, at the same temperature of the blend, are added without any additive. All components are mixed under strong agitation until a smooth plastic emulsion occurs. The resulting product is then used directly as a dairy fat substitute.

### EXAMPLE 2

A similar preparation to Example #1 has been prepared but with peanut oil.

### EXAMPLE 3

A preparation similar to Example 1 has been made except that 37.9 kg of water were used in which 6.7 of sugar were blended. The resulting gel behaves like a creamy mixture and has such rheological properties.

### EXAMPLE 4

A simple soft gel made from 20 kg of olive oil by heating it at 80° C. and to which 75.1 kg of water are added at the same temperature. 9.5 kg of sodium caseinate were mixed previously with the water in a cooker-cutter. Then the two components are emulsified together by a 6 blades knife until a plastic emulsion is obtained. The resulting food ingredient base is refrigerated and directly used as a fat substitute.

### EXAMPLE 5

A gel with a very loose texture, made from almond oil is made by mixing 10.0 kg of oil at 85° C. with 9.5 kg of hot sodium caseinate in a container where strong agitation is provided by a blade agitator. 85.1 kg of 85° C. water are added to reach a plastic emulsion. Then 2.4 kg of whey protein concentrate 34% are dissolved in the mixture. The resulting gel is frozen in 1 kg blocks for further usages.

### EXAMPLE 6

17.5 kg of the gel made according to EXAMPLE 1 is dissolved in 195 kg of skim milk, pasteurized and homogenized at 500 psi. The milk is then used to make cheddar according to regular practices. The resulting cheese has no cholesterol and bear ω-3 essential fatty acids.

### EXAMPLE 7

The milk produced in EXAMPLE 6 is rather homogenized at 2000 psi. and chilled to be drank as an ω-3 fluid milk without animal fat.

### EXAMPLE 8

100 liters of fluid milk containing 1% total fat is made by combining a partly skimmed milk (at 0.8% butter fat) with 460 g of our gel made from flaxseed oil. The mixture is subjected to a homogenizer at 2000 psi. and chilled. The resulting milk does contain 1.2 g of ω-3 per liter of milk.

### EXAMPLE 9

The milk produced in EXAMPLE 6 is used to make yoghurt by flowing the regular procedure well known to those skilled in the art.

### EXAMPLE 10

7.8 kg of canola oil are heated to 60.degrees.Celsius to which 1.64 kg of sodium caseinate are blended under vigorous agitation. 9.8 kg of 60.degrees.Celsius water are added under agitation with 1.0 kg of sugar and 0.5 kg of skim milk powder. The mixture is emulsified by passing through a Stephan pump and further homogenized at 1500 psi (first stage) and 500 psi (second stage). The resulting product id refrigerated and further used as a dairy fat substitute.

### EXAMPLE 11

Same procedure like EXAMPLE 10 but the sum of sugar and skim milk powder is replaced by 1.5 kg of whey powder.

### EXAMPLE 12

22.551 kg of the base of EXAMPLE 11 is blended in a liquifyer with 53.498 kg of eater (at room temperature), 2.635 kg of slim milk powder, 2.635 kg of whey powder, 0.779 kg of whey protein concentrate 34%, 1.317 kg of Glucose 22 DE, 14.965 kg of sugar, 0.1 kg of Mono 900 (monostearate) and 1.102 kg of Slendertex 1% (blend of mono- and di-glycerides). The mixture is left still for 24 hours at 4.degrees.Celsius. The following day the base is used to make frozen desserts by aiding vanilla, or cocoa, or a strawberry fruit sauce for examples and going through normal steps of ice cream malting procedures well known to those skilled in the art.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A dairy cream food ingredient substitute base comprising:
a. from about 2% to about 55% by weight of fat;
b. from about 5% to about 10% by weight of sodium caseinates, said sodium caseinates having a viscosity equal to or greater than 1 500 Pa·sec;
c. water for filling the total left weight to 100% by weight;
wherein said cream food ingredient contains neither emulsifiers nor thickeners.

13. The cream food ingredient substitute base according to claim 12, wherein said sodium caseinates have a viscosity equal to or greater than 2000 Pa·sec

14. The cream food ingredient substitute base according to claim 12, wherein said cream food ingredient further comprises from about 0% to about 25% by weight of lipophilic or hydrophilic food additives.

15. The cream food ingredient substitute base according to claim 13, wherein said cream food ingredient further comprises from about 0% to about 25% by weight of lipophilic or hydrophilic food additives.

16. The cream food ingredient substitute base according to claim 12, wherein said fat is an edible fat from a vegetable source or from a marine source or from a fish source or from an animal source or from a combination of two of more of said sources.

17. The cream food ingredient substitute base according to claim 13, wherein said fat is an edible fat from a vegetable source or from a marine source or from a fish source or from an animal source or from a combination of two of more of said sources.

18. The cream food ingredient substitute base according to claim 14, wherein said fat is an edible fat from a vegetable source or from a marine source or from a fish source or from an animal source or from a combination of two of more of said sources.

19. The cream food ingredient substitute base according to claim 12, wherein said cream food ingredient further comprises:
coloring agents; or
natural and/or artificial aromas; or
olfactory agents and/or preparations thereof; or
aromatic preparations; or
natural and/or artificial flavours; or
potentiators; or
bio-active and/or nutraceutical ingredients; or
micro-organisms; or
whole and/or hydrolyzed proteins; or
enzymes; or
antimicrobial food additives; or
antioxidants; or
stabilizers and/or surface active agents; or
acidulants; or
sweeteners; or
sequestrants agents; or
vitamins and/or amino acids; or
food stabilizers; or
organic minerals; or
inorganic minerals; or
food ingredients; or
medicines and/or drugs; or
a combination thereof.

20. A process for preparing a cream food ingredient substitute according to claim 12 which comprises the steps of:
heating a first hydrophobic component comprising at least one vegetable oil;
heating a second hydrophilic component comprising water;
adding high viscosity sodium caseinates to said first hydrophobic component and/or said second hydrophilic component at the same temperature;
blending said first hydrophobic component, said second hydrophilic component and said high viscosity sodium caseinates until a mixture having a smooth plastic texture is obtained.

21. A process according to claim 20, wherein said process further comprises the step of:
adding, under agitation, one or a plurality of intentional additives to said mixture.

22. A process according to claim 20, wherein said process further comprises the step of:
conditioning said mixture for refrigeration or for freezing.

23. Food products comprising at least partly a dairy cream substitute according to claim 12.
